(19) United States
(12) Patent Application Publication
(10) Pub. No.: US 2005/0058317 A1
(43) Pub. Date: Mar. 17, 2005

(54) Headgear and electronic components in combination

(76) Inventor: Robert D. Montgomery, Reno, NV (US)

Correspondence Address: ROBERT D. MONTGOMERY, 1685 W. 12th St., Reno, NV, 89503, US

(21) Appl. No.: 10/662,839

(22) Filed: Sep. 15, 2003

(51) Int. Cl. H04R 25/00; H04R 1/02

(52) U.S. Cl. 381/376; 381/182; 381/370; 381/388

(57) ABSTRACT

Headgear such as in the form of a baseball cap, visor, or headband, respectively, having electronic components concealed therein for performing electrical functions. Whereby the headgear when combined with such electronics provides a hat that can be used as either, a cell phone, a calculator, a computer, a palm pilot, or the like, and/or a combination there from. Also, the noted electronics can be housed within a removable container so as to allow the user to easily remove the electronics for washing and/or allowing the user to interchange the electronics between different types of headgear.

### FIELD OF THE INVENTION

The present invention relates in general to clothing worn by a user but more particularly pertains to headgear such as in the form of a hat that is used for performing electronic functions. For example, the hat may incorporate a communication system such as a cell phone, or it may include electrical components associated with a radio, a calculator, a computer, a mini-disc or CD player, etc., and also provides a keyboard on the hat for operation thereof.

### BACKGROUND OF THE INVENTION

Within the known prior art, there have been many attempts to incorporate some type of electronics within an article such as a helmet or other sports related item. This is useful when playing sports such as football or the like as this allows communication between players. Other types of related art include clothing such as vests, wherein the user may perform such tasks as inventory control and/or calculations pertaining to a certain job or project, etc. However, nowhere in the prior art did the applicants find an article in the form of headgear such as a “baseball cap” that includes electrical components for performing electrical functions, such as taught by the present invention.

It is contended by the applicant that there is a great need for a portable compact electronic article that can be easily inconspicuously concealed upon a person in a new and novel manner. For example, most people do not wish to carry with them cumbersome electronic devices such as lap-tops, cell phones, calculators, or the like, as due to their design they are not easily transported without the use of holders, cases, straps, or the like. Therefore, it would be most advantageous if one could wear a piece of clothing that includes appropriate electronics and which is substantially disguised within the piece of clothing, such as within a “baseball cap”. This is not only very convenient, but being many people wear such caps it would not appear out of the ordinary and they would not need to carry bulky devices such as incurred and taught by the known prior art.

However, a most important aspect of the present invention is to provide the electronics within a container or the like so as to be easily removably attached onto the garment, or more specifically the hat. This is most important as this allows the end user to remove the electronics from the hat for washing purposes. Or if preferred the electronics can be removed and attached to a different hat of their liking.

### SUMMARY OF THE INVENTION

It is therefore an object of the present invention to provide headgear, such as in the form of a baseball cap having electrical components disguised therein and which allows a user to perform electronic operations therewith, such as typically associated with cell phones, calculators, computers. For example, the invention can be used for text messaging and/or photos and their display, etc. and/or any other function associated with such electronic equipment.

It is another object of the present invention to provide a new and novel way for transporting and/or disguising electronics in a manner heretofore not taught.

Yet another object of the present invention is to provide headgear with electronics therein and optional features for performing operations pertaining to a specific use. For example, the electrical components may be functional as a radio, a cell phone, a laptop or the like, this is determined by the end user's desires and/or engineering choice, etc. It is to be understood that the electronics are to be contained within a removable container, respectively which allows for the end user to easily remove the electronics for washing purposes and/or for interchanging the electronics between different hats.

Still another object of the present invention is to provide headgear in the form of a baseball cap having electronics therein, including a keyboard positioned on the brim of the hat respectively, for easy operation thereof. Also the noted keyboard is constructed in a manner that allows the brim of the hat to remain flexible or bendable, which is very important. It is to be understood that the noted keyboard can be of the conventional type such as associated with computers, or it may be novel including different keystrokes and/or combinations thereof that perform specified tasks, such as there may be one key used for activating the phone, the CD or mini disc player, the calculator, or a palm pilot, etc. Furthermore, if so desired certain keys may be programmed by the operator for their personal needs, such as the key associated with the numeral one when pressed may automatically dial 911, or the like.

A further object of the present invention is to provide headgear in the form of a baseball cap having electronics therein, including a display panel for viewing information thereon. For example, the display panel may be digital and used for displaying messages normally associated with cell phone use, or the like.

Yet another object of the present invention is to provide headgear in the form of a baseball cap having electronics therein, including a solar battery charger and wafer type batteries housed within the sweatband area and/or upon the top section of the hat. The hat may also include a storage compartment for containment of a backup battery if so desired. Whereby, if the user notices the battery level is low, they have a backup battery on hand which is most convenient and in an emergency situation could be life saving. It is to be understood other types of energizing means may be incorporated, such as other non-solar type batteries and/or other energizing means that may be discovered within the field in the near future.

A further object of the present invention is to provide headgear in the form of a baseball cap having electronics therein, including a microphone mounted onto a earpiece, with the earpiece being hinged and adjustable between numerous positions of user choice. Also, the earpiece when not in use can be easily folded into a concealed position within the hat.

Still another object of the present invention is to provide headgear in the form of a baseball cap having electronics therein which is adjustable in size for use by individual users.

Other objects and advantages will be seen when taken into consideration with the following drawings and specification.

### BRIEF DESCRIPTION OF THE DRAWINGS

FIG. 1 is substantially a top overview depicting a first embodiment for the present invention.

FIG. 2 is substantially a plan view for the associated electronics pertaining to the embodiment of FIG. 1.

FIG. 3 is substantially a top overview depicting a second embodiment for the present invention.

FIG. 4 is substantially a plan view for the associated electronics pertaining to the embodiment of FIG. 3.

FIG. 5 is substantially a top view depicting different keyboards and different buttons and/or keystrokes in combination.

### DETAILED DESCRIPTION OF THE DRAWINGS

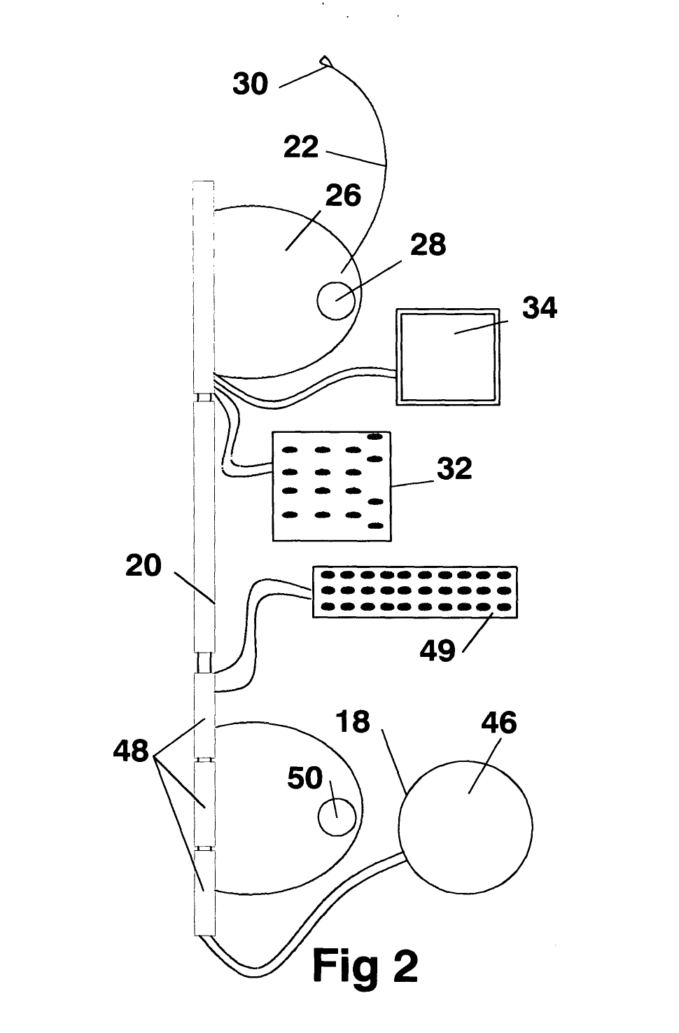

Referring now in detail to the drawings wherein like characters refer to like elements throughout the various views. The present invention is substantially a means for intergrading headgear and electronics in combination in a concealed manner. Whereby, the present invention can be used for performing electrical functions such as those associated with computers, cell phones, calculators, or the like. The headgear and electronics can be combined within any suitable type of headgear, including visors, headbands, or the like. This is easily accomplished as the noted electronics (22) can be housed within a removable container (not numbered) such as exemplified within FIG. 2 and then attached onto any suitable type of headgear according to user choice. For example, the headgear may be in the form of a headband having a brim (12) with the headband having internal electrical components (22) and the brim having internal electrical components (22), each of which are activated by suitable activation means (later described) that is included on the headgear. Also it is important to note the internal electrical components (22) can be fixedly attached or if preferred they may be removably attached within the headgear.

Other embodiments include substantially a hat (10) that is formed from a brim (12) interconnected to a cap (14), with the brim (12) having a top area (16) and the cap (14) having a top section (18), and a sweatband section (20), respectively. The brim (12) includes internal electrical components (22) therein, the cap (14) having internal electrical components (22) therein and top area (16) having activation means for activating the noted internal electrical components (22). It is to be understood the actual electronics are not taught or provided herein as such electronics and such functions are very well known in the field.

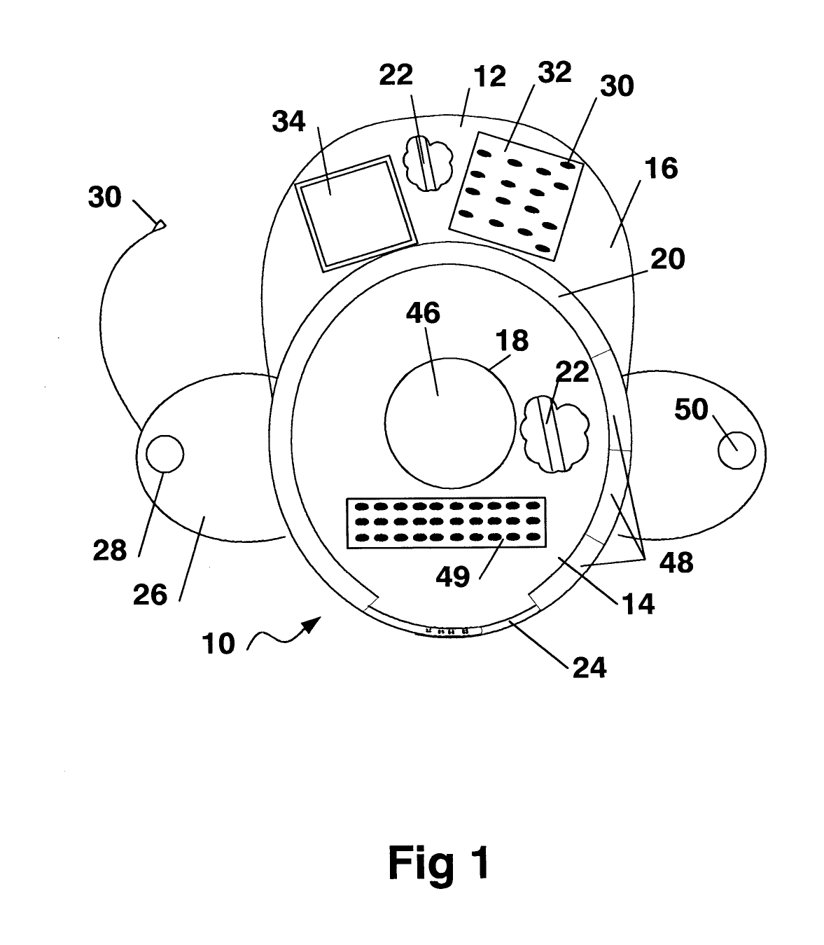

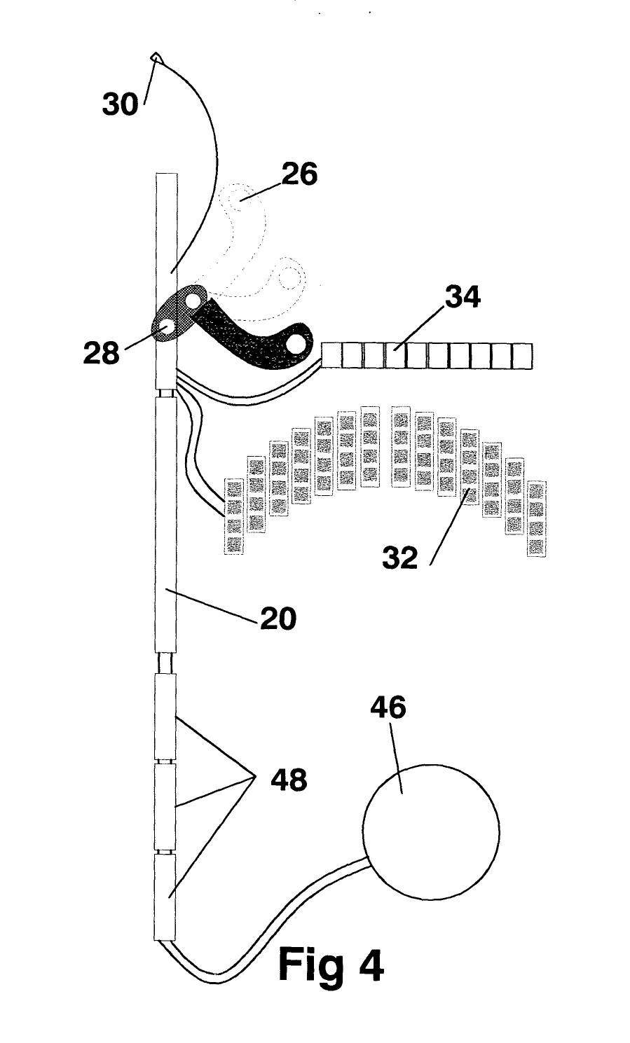

As further depicted within FIGS. 1-4, the present invention is constructed in the typical manner, so as to be adjustable and wearable by users of different sizes. Thus, the hat (10) further includes suitable adjustment means (24) such as interconnecting straps and a fastener or the like.

Still further depicted throughout the various views, hat (10) also includes an earpiece (26) that is electrically interconnected to a speaker (28) and a receiver (30). Furthermore, the earpiece (26) is attached onto the hat (10) via a hinge mechanism (28). Whereby, earpiece (26) may be conveniently folded into a concealed position within hat (10), respectively. This is also very important as this allows for individual users to position the earpiece (26) into the exact position of their liking.

Referring now to the previously noted activation means for activating the internal electrical components (22). Whereby, the activation means includes the following either individually and/or in combination thus the invention incorporates the following but is not limited thereto. For example, as depicted in FIGS. 1-4, the activation means includes at least an on/off switch (30), which can be mounted separately or onto a keyboard (32) and at least one display panel (34). It is to be understood the presently depicted keyboard (32) and display panel (34) are only exemplary of some types of keyboards and display panels as there are numerous variations of both although such variations can be easily incorporated herein.

Referring now to the noted internal electrical components (22) and there function. Again, it is to be understood that such components are only exemplary of some suitable combinations therefore the invention is not to be limited thereto. For example, internal electrical components (22) when activated by the activation means, may function as either a cell phone (36), a computer (38), a calculator (40), a CD or mini disc player (40), a palm pilot (44), or the like or a combination thereof. It is to be understood that the CD or mini disc player can be inserted into a proper receptacle located beneath the solar battery charger if so desired, or onto any other suitable location of engineering choice. It is to be further understood that the noted keyboards, display, etc., can be arranged in numerous ways, such as the display panel maybe positioned differently onto the hat such as onto the cap section or the keyboard and display maybe inverted so as to allow the brim and hat to resemble a computer setup, or the like.

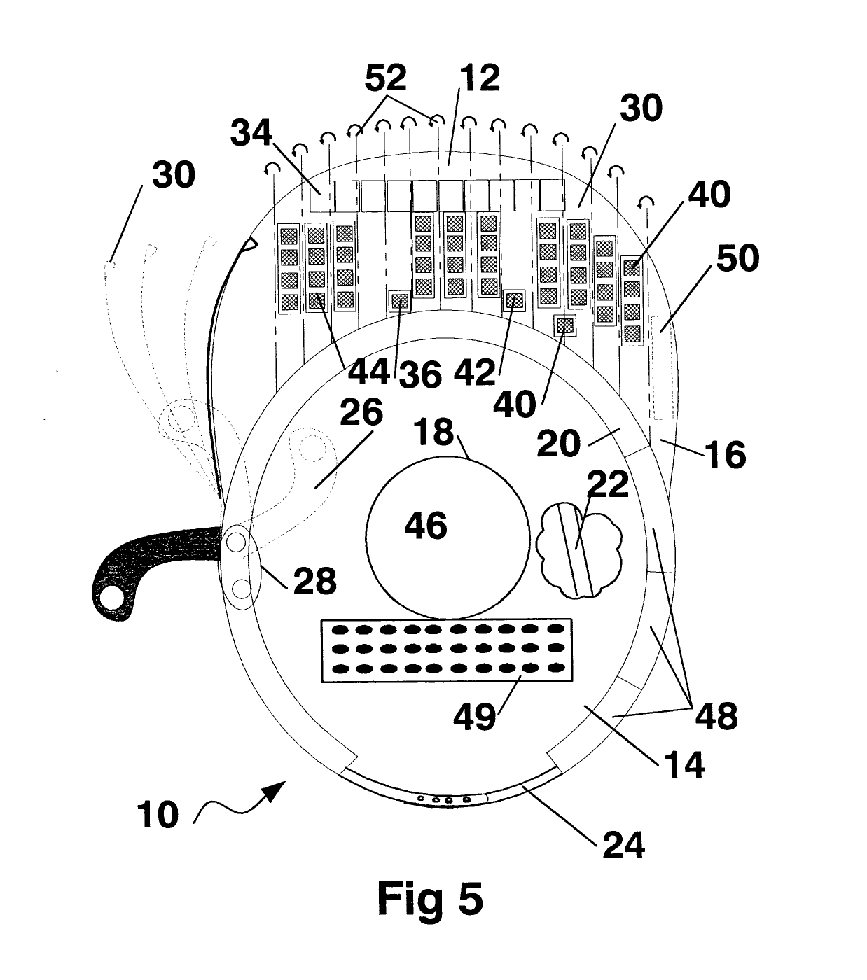

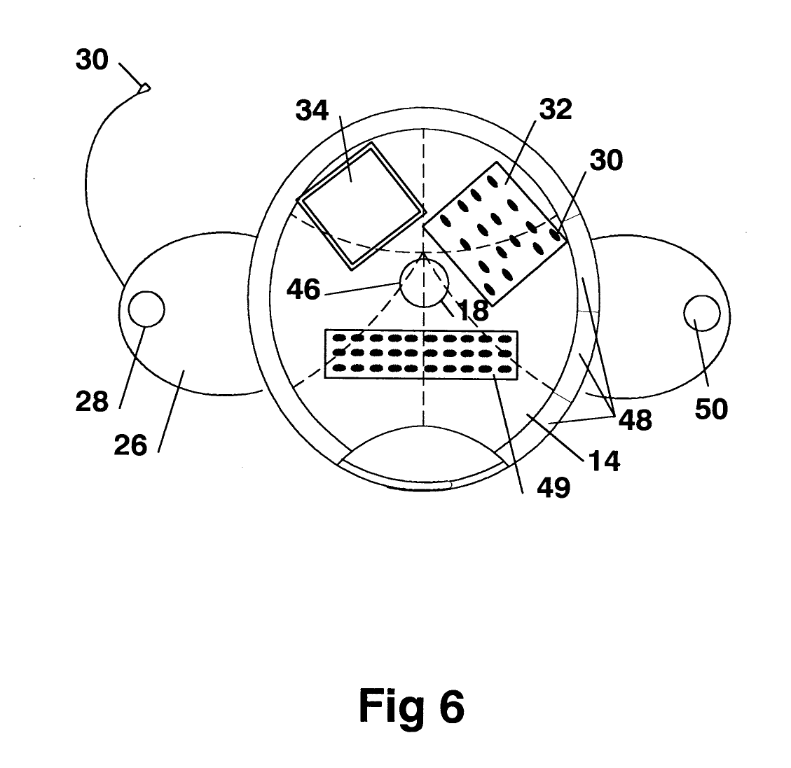

As further depicted in FIGS. 1-5, the electrical components can include a solar battery charger (46) and wafer batteries (48). Again, these components are only exemplary as other types of energizing means may easily be incorporated depending on engineering choice.

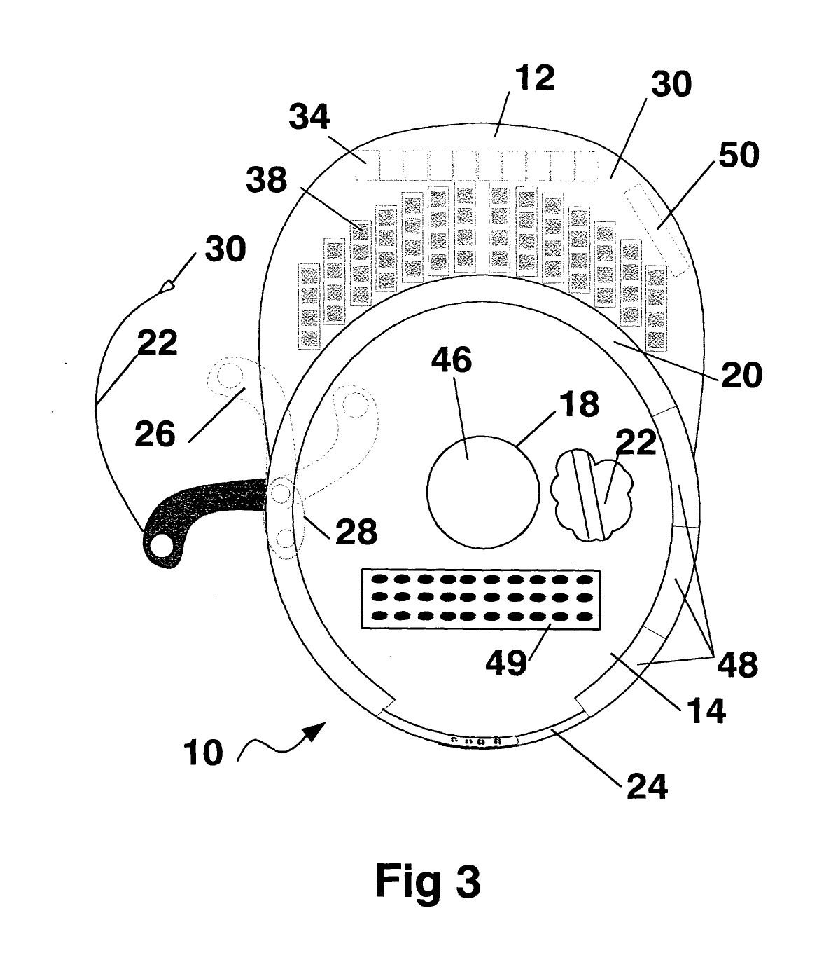

Yet another option for the present invention may be to include a storage compartment (50) for containment of a backup battery (not shown), such as depicted in FIG. 3. This is most advantageous as most all cell phone users know how disturbing it can be when your battery dies in the middle of a conversation. In fact, such a battery backup may be lifesaving in an emergency.

Still a further option for the present invention is to include within the brim (12) at least one hinge mechanism (52) so as to allow the brim to be flexible or bendable. This is very important as this not only improves comfort for the wearer but more importantly will reduce the likelihood of the internal electronics being broken due to stress or the like.

It will now be seen I have herein provided a new and novel invention for incorporating in combination headgear and electronics in a concealed manner heretofore not taught. The headgear or namely, the “hat” and electronics can be used for substantially any type of electronic function depending on engineering choice. The hat includes a novel earpiece which can be folded in a concealed manner when not in use, yet it can also be easily moved between numerous positions for individual user comfort. Also, the hat may be made from any suitable material of engineering choice, such as cloth, plastic, Nylon, etc., and it may be waterproof which is most advantageous. Still further the present headgear may be any suitable type of headgear including a headband or the like and a very important feature is the internal electronic components may be housed within a container that may be either fixedly attached therein or they may be removably attached.

Although the invention has been herein shown and described in what is conceived to be the most practical and preferred embodiment, it is recognized that departures may be made there from within the scope and spirit of the invention, which is not to be limited to the details disclosed herein but is to be accorded the full scope of the claims so as to embrace any and all equivalent devices and apparatuses.

1. Headgear and electronics in combination comprising: a hat formed from a brim interconnected to a cap, said brim having a top area, said cap having a top section and a sweatband section, said brim having internal electrical components therein, said cap having internal electrical components therein, and said top area having activation means for activating said internal electrical components.

2. The headgear and electronics in combination of claim 1 further including adjustment means for variably adjusting the size of said cap.

3. The headgear and electronics in combination of claim 1 wherein said hat further including an earpiece electrically interconnected to a speaker and receiver.

4. The headgear and electronics in combination of claim 3 wherein said earpiece is further attached via a hinge mechanism, whereby, said earpiece may be conveniently folded into a concealed position within said hat, respectively.

5. The headgear and electronics in combination of claim 1 wherein said activation means includes at least one keyboard.

6. The headgear and electronics in combination of claim 1 wherein said activation means includes at least an on/off switch.

7. The headgear and electronics in combination of claim 1 wherein said brim further includes at least one display panel thereon.

8. The headgear and electronics in combination of claim 1 wherein said internal electrical components when activated by said activation means function as a cell phone.

9. The headgear and electronics in combination of claim 1 wherein said internal electrical components when activated by said activation means function as a computer.

10. The headgear and electronics in combination of claim 1 wherein said internal electrical components when activated by said activation means function as a calculator.

11. The headgear and electronics in combination of claim 1 wherein said internal electrical components when activated by said activation means function as a CD player.

12. The headgear and electronics in combination of claim 1 wherein said internal electrical components when activated by said activation means function as a mini-disc player.

13. The headgear and electronics in combination of claim 1 wherein said internal electrical components when activated by said activation means function as a palm pilot.

14. The headgear and electronics in combination of claim 1 wherein said cap having internal electrical components therein, said electrical components including a solar battery charger and wafer batteries.

15. The headgear and electronics in combination of claim 1 wherein said hat further includes a storage compartment for containment of a backup battery.

16. The headgear and electronics in combination of claim 1 wherein said brim includes at least one hinge so as to allow said brim to be flexible.

17. The headgear and electronics in combination of claim 1 wherein said internal electrical components are housed within a container that is removably attached onto said hat, whereby said internal electrical components can be easily removed from said hat for washing purposes.

18. Headgear and electronics in combination comprising: headgear in the form of a headband having a brim, said headband having internal electrical components, said brim having internal electrical components, and said headgear having activating means for activating said internal electrical components.

19. The headgear and electronics in combination of claim 18 wherein said internal electrical components are removably attached within said headgear.
